(19) United States
(12) Patent Application Publication
(10) Pub. No.: US 2004/0094047 A1
(43) Pub. Date: May 20, 2004

(54) Refuse compactor system with vertical compacting device

(76) Inventor: Laurence Michael Byrne, Wagga Wagga (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/416,722

(22) PCT Filed: Nov. 14, 2001
(86) PCT No.: PCT/AU01/01480

(30) Foreign Application Priority Data
Nov. 14, 2000 (AU) PR 1450

(51) Int. Cl. B30B 15/02

(52) U.S. Cl. 100/225

(57) ABSTRACT

A compactor system (10) for compacting loose refuse or solids at a transfer station that provided consolidation of waste and transfer to specialised vehicles which take the compacted waste on to a final disposal site. The compactor system comprises a refuse receiving volume or compartment (16) for receipt or filling of loose refuse (25), a compacting device (11) to provide a vertical compacting force by ram operated movable base (19) and/or top (20) walls acting on the refuse within the volume (16) to form a compacted refuse load, and a compacted load transfer device (12) having a ram operated movable vertical surface (22) to move the load horizontally and into a refuse transport means or vehicle (15) via the end (13) closed with a movable end surface (21). The top wall (20) can be pivotally opened upwards to allow refuse to be tipped into the volume (16) along the entire length.

The present invention relates to a compactor system and, more particularly, to such a system suited for use in a transfer station and more particularly for use in association with compactable solids such as but not limited to solids waste material.

### BACKGROUND

It is vital to the good health of people in any urban setting that household, commercial and industrial refuse including putrescable waste be periodically collected and removed to a disposal site which, typically, can comprise a landfill. Given that the disposal sites are often located geographically distant from the initial points of collection of the refuse it is typically the case that local transfer stations are established where refuse is brought for consolidation and transfer to specialized transport vehicles which take the waste on to the final disposal site.

In many current transfer stations attempts are made to compact the consolidated refuse for the purposes of achieving volumetric efficiency of storage in the specialized vehicles used for transporting the refuse to its final disposal site.

One current system involves linear, iterative horizontal compaction in conjunction with the urging of the waste into the specialized transport vehicle.

This particular arrangement requires powerful hydraulic rams and also tends to cause unbalanced loading including very high peak loads on various portions of the associated structures.

It is an object of the present invention to overcome or ameliorate the above mentioned disadvantages.

### BRIEF DESCRIPTION OF INVENTION

Accordingly, in one broad form of the invention there is provided a compactor system for use in a refuse transfer station; said compactor comprising a refuse receiving volume for receipt of loose refuse; a refuse compacting device for compacting the loose refuse within said refuse receiving volume and wherein said compacting device is adapted to apply compacting force to said refuse in a vertical direction from below so as to form a compacted refuse load; a compacted refuse load transfer device for transferring the compacted refuse load to a refuse transport means.

Preferably said refuse compacting device applies compacting force in a substantially vertical direction to said loose refuse within said refuse receiving volume.

Preferably said refuse compacting device applies compacting force in a substantially vertical direction throughout the length and width of said refuse receiving volume.

Preferably said substantially vertical direction is a downward vertical direction from above said loose refuse.

Preferably said compacting force is released from said refuse sufficient to permit transferring the compacted refuse load to said refuse transport means.

Preferably said compacting force is applied to said loose refuse alternately in a downward vertical direction and an upward vertical direction.

Preferably said compacted refuse load transfer device transfers said compacted refuse load in a substantially horizontal direction.

Preferably said compacted refuse load transfer device transfers said compacted refuse load in one continuous movement.

Preferably said compacted refuse load transfer device transfers said compacted refuse load to said refuse transport means by urging of said compacted refuse load in a direction substantially perpendicular to the direction of operation of said refuse compacting device.

In a further broad form of the invention there is provided a refuse compacting device for use with the compactor system outlined above, said refuse compacting device incorporating compacting means which acts substantially perpendicular to a longitudinal axis of a refuse receiving volume defined within said refuse compacting device.

In yet a further broad form of the invention there is provided a method of compacting loose refuse at a refuse transfer station prior to transferring said refuse to a refuse transport means; said method comprising the steps of:

(a) loading up to a predetermined quantity of loose refuse into a refuse receiving volume;

(b) compacting said loose refuse so as to form a compacted refuse load by application of a compacting force to said loose refuse in a substantially vertical direction;

(c) releasing said compacting force from said refuse sufficient to permit transfer without further compaction of said compacted refuse load in a direction substantially perpendicular to said vertical direction from said refuse receiving volume into a refuse transport means.

In yet a further broad form of the invention there is provided a compactor system for use in a solids transfer station; said compactor system comprising a solids receiving volume for receipt of loose solids; a solids compacting device which acts substantially perpendicular to a longitudinal axis of said refuse receiving volume for compacting the loose solids within said solids receiving volume so as to form a compacted solids load; a compacted solids load transfer device for transferring the compacted solids load to a solids transport means; wherein said solids compacting device is adapted to the releasing of the compacting force sufficient to allow transfer of said compacted solids load.

Preferably said solids compacting device applies compacting force in a substantially vertical direction to said loose solids within said solids receiving volume.

Preferably said solids compacting device applies compacting force in a substantially vertical direction throughout the length and width of said solids receiving volume.

Preferably said substantially vertical direction is a downward vertical direction from above said loose solids.

Preferably said substantially vertical direction is an upward vertical direction from below said loose solids.

Preferably said compacting force is applied to said loose solids alternately in a downward vertical direction and an upward vertical direction.

Preferably said compacted solids load transfer device transfers said compacted solids load in a substantially horizontal direction.

Preferably said compacted solids load transfer device transfers said compacted solids load in one continuous movement.

Preferably said compacted solids load transfer device transfers said compacted solids load to said solids transport means by urging of said compacted solids load in a direction substantially perpendicular to the direction of operation of said solids compacting device.

In yet a further broad form of the invention there is provided a solids compacting device for use with the compactor system outlined above, said solids compacting device incorporating compacting means which acts substantially perpendicular to a longitudinal axis of a solids receiving volume defined within said solids compacting device. (21)

Preferably said compacted refuse load transfer device is independent of the operation of said refuse compacting devices. (22)

In yet a further broad form of the invention there is provided a method of compacting loose refuse at a refuse transfer station as outlined above; said method further including the step of transferring said compacted refuse load in a transfer step independent of said step of compacting. (23)

In yet a further broad form of the invention there is provided a method of compacting loose solids at a solids transfer station prior to transferring said solids to a solids transport means; said method comprising the steps of:

(a) loading up to a predetermined quantity of loose solids into a solids receiving volume;

(b) compacting said loose solids so as to form a compacted solids load by application of a compacting force to said loose solids in a substantially vertical direction;

(c) releasing said compacting force from said solids sufficient to permit transfer of said compacted solids load from said solids receiving volume to a refuse transport means. (24)

In yet a further broad form of the invention there is provided a compactor system for retrofitting to a transfer station; said compactor system comprising a moveable top surface adapted to move between a loading position and a compacting position; said compactor system further including a longitudinal transfer device; said top surface adopting a loading position during loading of solids into a pre-existing receiving volume; said moveable top surface adopting a compacting position located substantially over said receiving volume during compacting of said solids material; said longitudinal transfer device adapted to urge compacted solids material in a horizontal direction from said receiving volume following compaction of solids material therewithin.

Preferably said longitudinal transfer device is operable independently of said moveable top surface.

Preferably said transfer device urges compact material in one movement along the entire length of said top surface.

In yet a further broad form of the invention there is provided a method of retrofitting a pre-existing transfer station having a pre-existing volume therein; said method comprising adding to said transfer station a compactor system as outlined above.

Preferably said longitudinal transfer device is operable independently of said moveable top surface. (29)

Preferably said transfer device urges compact material in one movement along the entire length of said top surface.

### BRIEF DESCRIPTION OF DRAWINGS

Embodiments of the present invention will now be described with reference to the accompanying drawings wherein:

FIG. 1A is a side view of a compactor system according to a first embodiment of the present invention;

FIG. 1C is an end section view of a compactor portion of the compactor system of FIG. 1A in a refuse receiving position;

FIG. 1D is an end section view of the compactor portion of FIG. 1C in a discharge position;

FIG. 2 is a side, partially cut away view of the compactor system of FIG. 1A with a trailer in a loading position;

FIG. 3 is a side, partially cut away view of the compactor system and trailer of FIG. 2 with compacted refuse transferred to the trailer;

FIG. 4 is a side, partially cut away view of the compactor system of FIG. 1A with the compacting portion closed ready for compaction;

FIG. 5 is a side, partially cut away view of the compactor system of FIG. 4 showing the compacting portion in an unloading or discharge position;

FIG. 6 is a side, partially cut away view of the compactor system of FIG. 4 immediately after unloading or discharge;

FIG. 7 is an end section view of the compacting portion of the compactor system of FIG. 4 in a loading position;

FIG. 8 is an end section view of the compacting portion of the compactor system of FIG. 4 in a lock down position;

FIG. 9 is an end section view of the compacting portion of the compactor system of FIG. 4 in a first stage compaction position;

FIG. 10 is an end section view of the compacting portion of the compactor system of FIG. 4 in a second stage compaction position;

FIG. 11 is an end section view of the compacting portion of the compactor system of FIG. 4 in a discharge position;

FIG. 12A is a side, partly sectioned view of a compactor system according to a second embodiment of the present invention;

FIG. 12B is an end, partly sectioned view of the compactor system of FIG. 12A;

FIG. 13 is a side section view of a compactor system according to a third embodiment of the present invention; and

FIG. 14 is a side section view of the compactor of FIG. 13 in a fully compacting position.

### DETAILED DESCRIPTION OF PREFERRED EMBODIMENTS

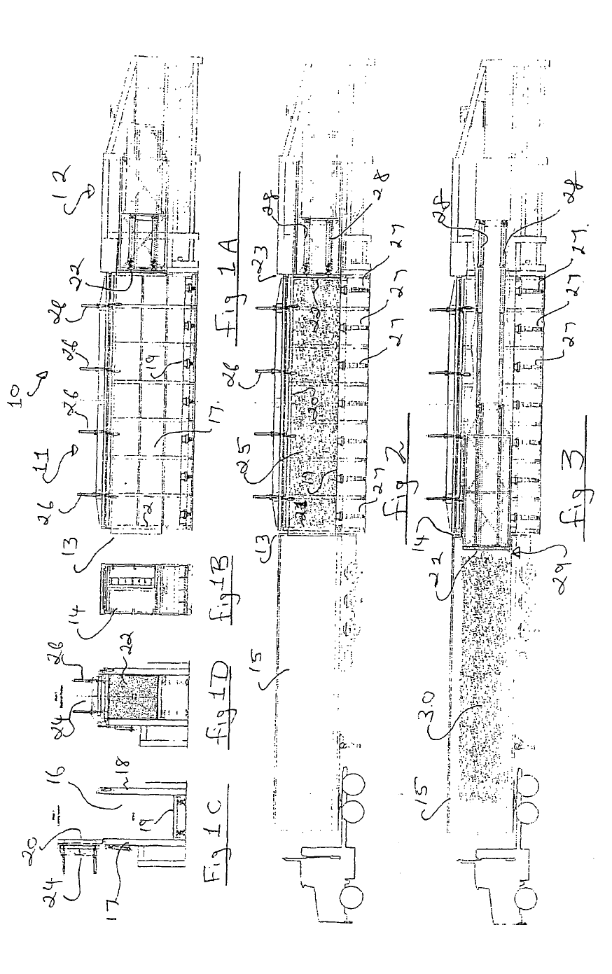

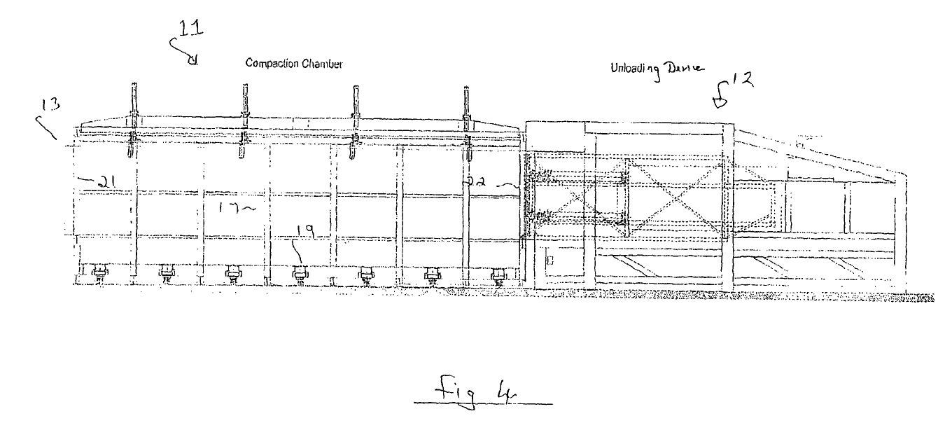

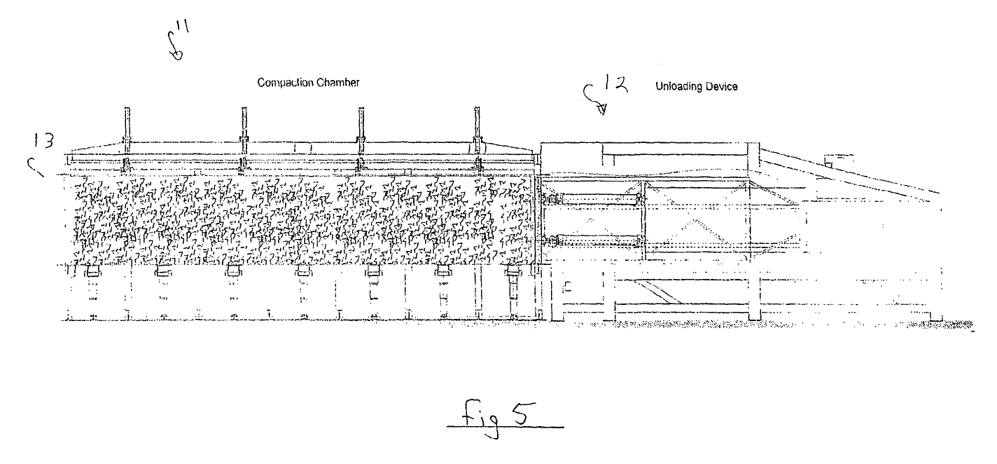

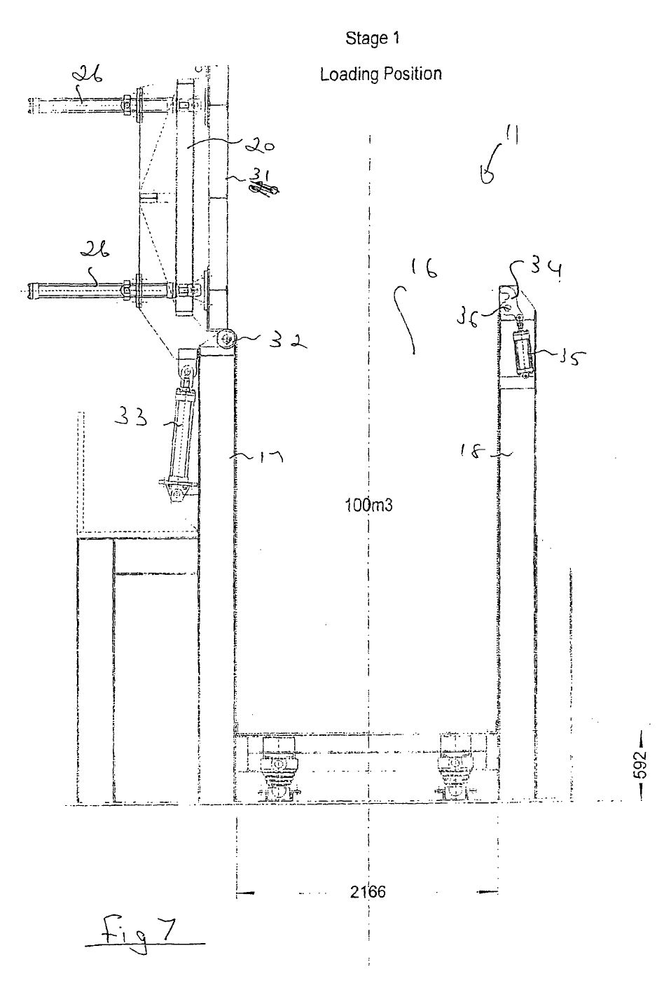

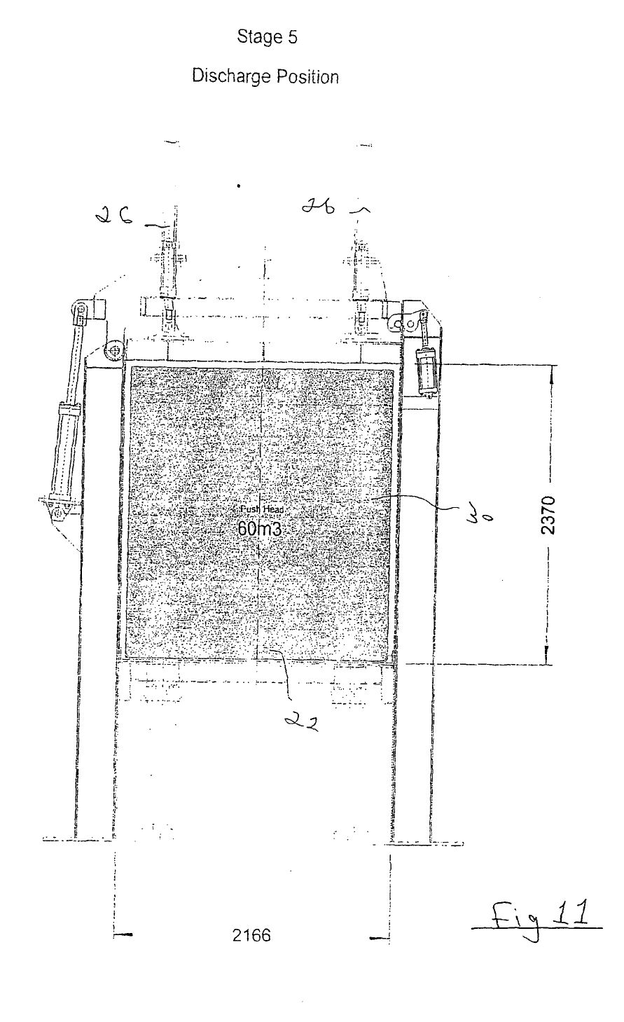

A first preferred embodiment of a compactor system 10 will be described with initial reference to FIGS. 1 through to 3. Detailed operation of the compactor system 10 will then be described in more detail with reference to FIGS. 4 to 11 inclusive.

With initial reference to FIG. 1, the compactor system 10 of the first preferred embodiment comprises a compacting portion 11 or refuse compacting device 11 operatively associated, in this instance, with a compacted refuse load transfer device 12.

The compactor system 10 is adapted to receive at a discharge end 13 thereof, in this instance, the rear end 14 of a trailer 15.

The refuse compacting device 11 comprises an elongate receiving volume 16 defined by first and second, substantially parallel spaced apart walls 17, 18 respectively and further bounded and defined by moveable surfaces comprising, in this instance, moveable base surface 19, moveable top surface 20, moveable discharge end surface 21 and moveable unloader surface 22 located at a working end 23 of compacted refuse load transfer device 12.

In use, as will be described in greater detail below, a top surface support unit 24 initially adopts an open position as illustrated in FIG. 1C thereby to allow loose refuse 25 to be tipped into receiving volume 16 along the entire length thereof defined between discharge end 13 and working end 23.

Once the filling operation has been completed the top surface support unit 24 is moved to a closed position as shown in FIG. 1D and FIGS. 2 and 3. Compaction of the loose refuse 25 then takes place by first lowering top surface 20 with respect to top surface support unit 24 whereby the surface moves in a substantially downward vertical direction causing an initial decrease in the volume of receiving volume 16. In this instance the downward vertical movement is effected by a set of distributed upper rams 26.

Receiving volume 16 is then caused to further contract by the raising of base surface 19 by use of a set of distributed lower rams 27. The compaction of the loose refuse 25 thereby takes place, in this instance, in a two stage process. Specifically, in this instance, compaction pressure is applied by vertical movement, in the first stage in a downward direction and in a second stage in an upward direction relative to the loose refuse 25 within receiving volume 16.

It will be further observed that the downward movement is effected across an entire top surface of the loose refuse 25 within receiving volume 16 and, similarly, the upward compaction movement is also effected across an entire base surface of the loose refuse 25 within the receiving volume 16.

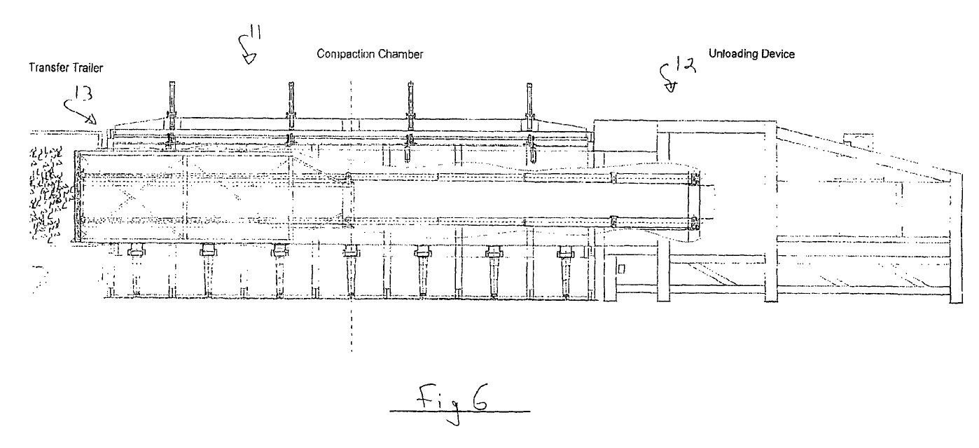

Once the first and second stages of compaction are completed the refuse compacting device 11 adopts a discharge position as seen in FIG. 3 where lower rams 27 remain at their extended (compacting) position whilst upper rams 26 retract substantially and sufficient to define an end cross section to receiving volume 16 which permits passage there through along a longitudinal axis thereof of unloader surface 22 when urged there through by urging means in the form, in this instance, of discharge rams 28.

As shown in FIG. 3, the discharge rams 28 extend sufficiently to urge unloader surface 22 along a longitudinal axis of receiving volume 16 and all the way through the volume 16 so as to adopt an end discharge position 29 located beyond discharge end 13 of compacting device 11 and at least partially within the interior of trailer 15. The compacted refuse load 30 is thereby transferred in a single linear, continuous motion from receiving volume 16 entirely into trailer 15.

Preparatory to accepting a new load of loose refuse 25 the moveable surfaces 19, 20, 21, 22 return to their starting positions.

The process adopted by the compaction system 10 will now be described in additional detail with reference to FIGS. 4 to 11 inclusive and wherein like components are numbered as for FIGS. 1 to 3 inclusive.

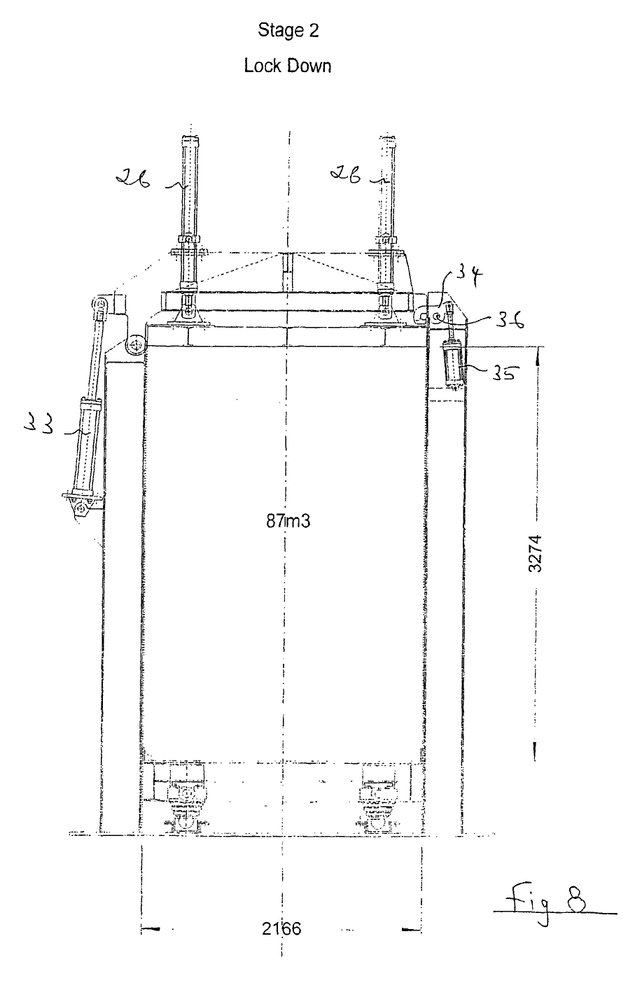

FIG. 4 illustrates the compactor system 10 in the position shown in FIG. 1A. FIG. 5 illustrates the compactor system 10 in the position illustrated in FIG. 2. FIG. 6 illustrates the compactor system 10 in the discharge position of FIG. 3.

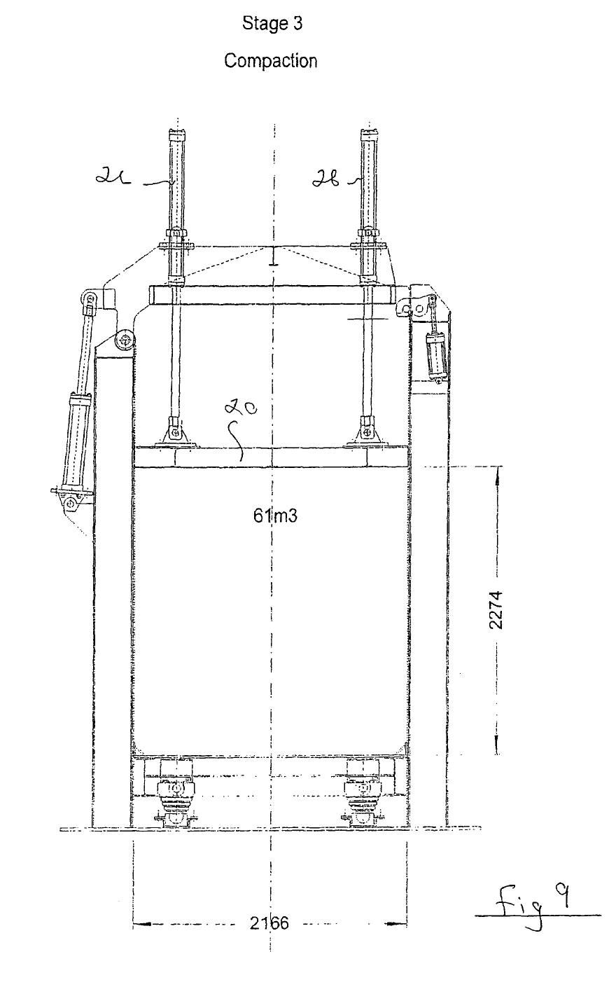

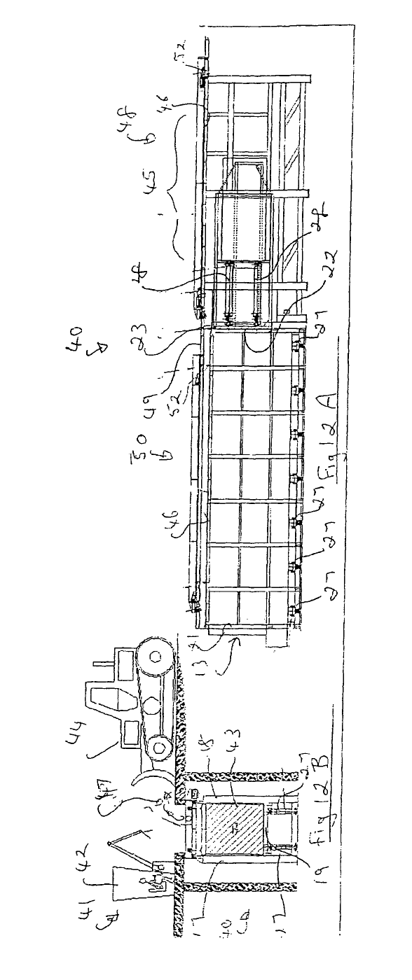

FIGS. 7 to 11 inclusive illustrate end section views of the refuse compacting device 11 moving from FIG. 7 which illustrates the loading position analogous to FIG. 1C through to FIG. 11 which illustrates the discharge position analogous to the position shown in FIG. 1D and FIG. 3.

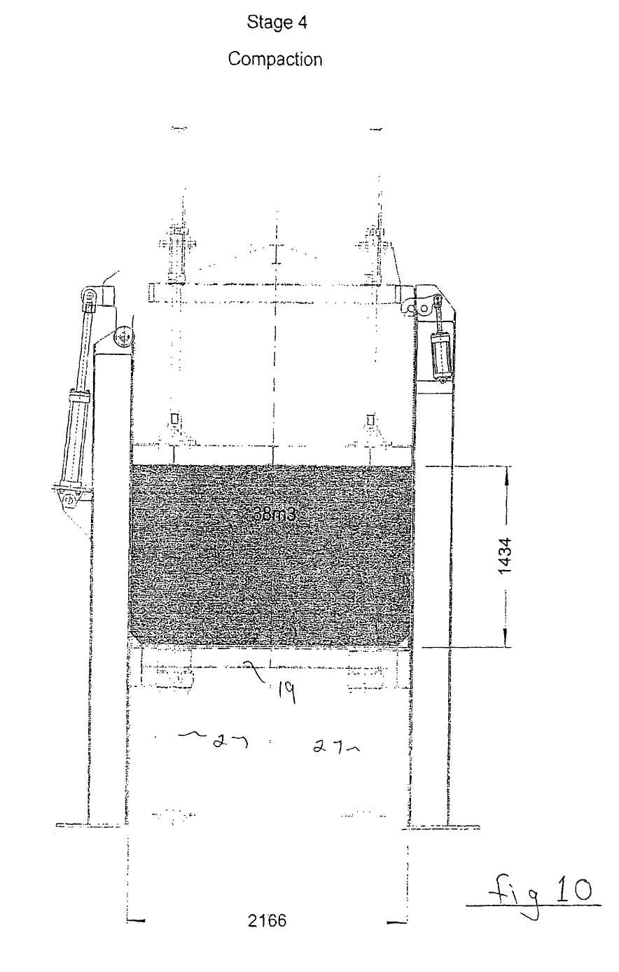

With reference to FIG. 7 the refuse compacting device 11 includes a receiving volume 16 which, in its loading position for this example is defined as 100 cubic metres. Moveable top surface 20 is supported with respect to locking plate 31 by way of upper rams 26. The locking plate 31 is moveable from its open, loading position as illustrated in FIG. 7 by pivoting about pivot 32 to a lock down position illustrated in FIG. 8. The locking plate 31 is moved between the two positions by the action of locking plate ram 33. Once in the lock down position illustrated in FIG. 2 the locking plate 31 is locked in place by lock arm 34 which itself is moved between an unlocked and locked position by lock ram 35 which pivots lock arm 34 about lock arm pivot 36. In this example, once locking plate 31 is in the lock down position of FIG. 8 the volume defined within receiving volume 16 is 87 cubic metres.

With reference to FIG. 9 a first stage of compaction of the loose refuse 25 within volume 16 is achieved by extending rams 26 whereby top surface 20 moves in a vertically downward direction relative to receiving volume 16 whereby the volume of receiving volume 16 is reduced, in this example, to 61 cubic metres.

A second stage of compaction is then effected as illustrated in FIG. 4 by the extending of lower rams 27 whereby base surface 19 is moved vertically upwardly relative to volume 16 thereby to further reduce the volume of receiving volume 16, in this example to a volume of 38 cubic metres.

Having achieved maximum compaction of the previously loose refuse 25 within volume 16 the compacting pressure is relieved by raising of upper rams 26 so as to raise vertically top surface 20 thereby to define a discharge position for the compacted refuse load 30 which, in this example, now occupies a volume of 60 cubic metres.

In particular the arrangement and relative spacing of moveable surfaces 19, 20, 21, 22 is adjusted so as to permit passage through volume 16 along a longitudinal axis thereof of unloader surface 22 acting, in this instance, as a push head whereby, in one contiguous, linear movement the entire compacted refuse load 30 is moved, as previously illustrated with particular reference to FIG. 3, from within volume 16 to entirely exterior of volume 16, in this instance to trailer 15.

It will be observed, in this embodiment, that compaction takes place in a direction perpendicular to the longitudinal axis of volume 16 thereby permitting use of an array of relatively small capacity rams 26, 27.

It will be noted that whilst rams 28 require the ability to extend along the full longitudinal length of volume 16 and must overcome any frictional load imposed between compacted refuse load 30 and surfaces 19, 20, 21, 22 the ram 28 is not required to perform any compacting function.

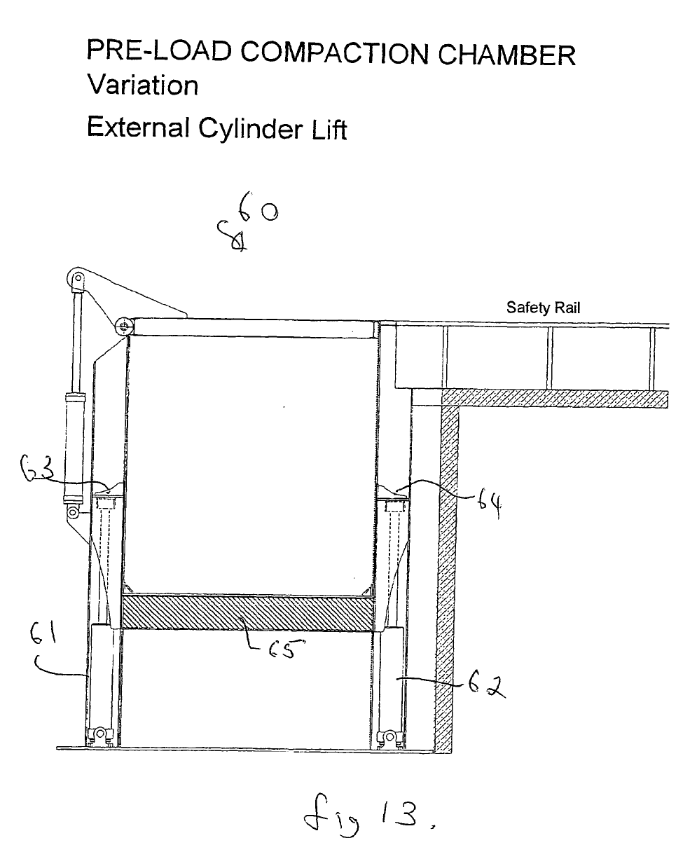

With reference to FIGS. 12A, 12B a second embodiment of a compactor system 40 will now be described. The compactor system 40 of the second embodiment is particularly suited to retrofitting to an existing transfer station 41 and more particularly to such transfer stations where headroom can be a problem.

The existing transfer station 41 can be of the type where rudimentary compaction is performed by a tamping down machine 42. The tamping down machine 42 comes into operation after loose solids material such as waste has been urged into a receiving volume 43 by, in this instance, front-end loader 44.

In this embodiment like components are numbered as for the first embodiment and include moveable base surface 19 urgable vertically upwardly by distributed lower rams 27 subtended by side walls 17, 18 thereby to define a receiving volume 43 there within which is subtended at a working end 23 by a moveable unloader surface 22. The moveable unloader surface 22 is urgable in a horizontal direction by discharge rams 28 forming the working part of longitudinal transfer device 45 analogous to compacted load transfer device 12 of the first embodiment.

At least during a filling operation of volume 43. discharge end 13 is closed by discharge end surface 21.

In this embodiment volume 43 is closable by means of a horizontally moveable top surface 46.

Whilst volume 43 is being filled with loose solids material 47 the top surface 46 is located at loading position 48 which, in this instance, overlays the longitudinal transfer device 45.

Once sufficient loose solids material 47 is located within volume 43 the top surface 46 is moved along rails 49 in a horizontal direction to the point where it adopts a compacting position 50 overlaying volume 43 and thus closing volume 43 and so as to provide a reaction surface against compacting forces then caused by raising of base surface 19 by the upward vertical urging of lower rams 27 so as to cause volume 43 to become reduced to a volume of cross section as shown hatched in FIG. 12B.

The horizontally moveable top surface 46 can include cam lock means 52 which moves with the top surface 46 and which adopts a locking position when top surface 46 is in its compacting position 50 thereby to latch top surface 46 to side walls 17, 18 or other restraint whereby top surface 46 can better resist the upward urging forces derived from the raising of base surface 19 during a compaction operation.

On completion of the compaction step the compacted solids load 51 is then urged in a substantially horizontal direction and along the longitudinal axis of volume 43 by means of horizontal movement of unloader surface 22 under the influence of discharge rams 28 and into solids transport means (not shown).

In a particular form longitudinal transfer device 45 together with rails 49 and horizontally moveable top surface 46 can be retrofitted to existing transfer station 41 and, in particular forms, the action of the tamping down machine 42 retained.

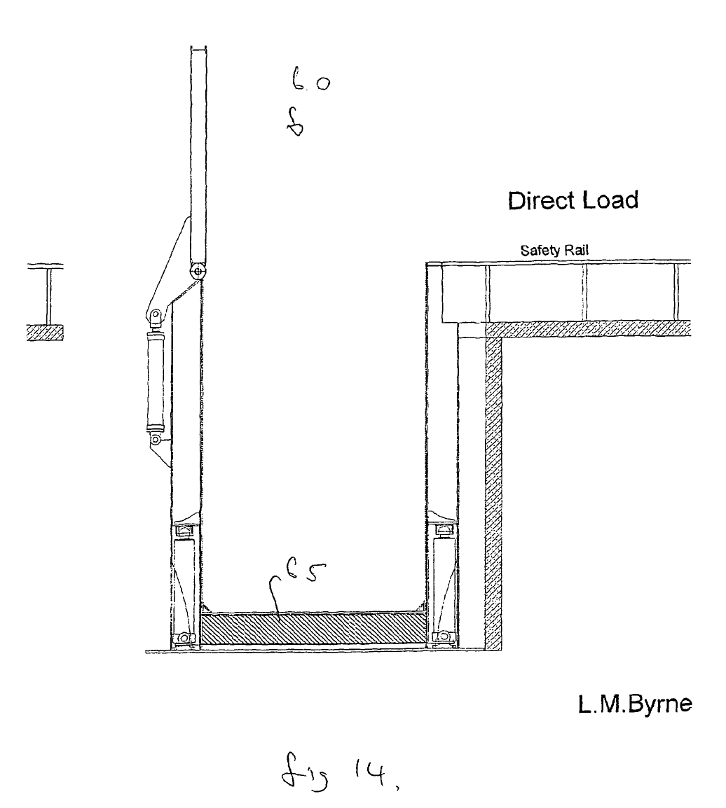

With reference to FIGS. 13 and 14 there is illustrated a compactor system 60 in accordance with a further preferred embodiment of the present invention.

In this embodiment the distributed upper rams 26 of earlier embodiments are replaced by external side cylinders 61, 62 operating through respective linkages 63, 64 to urge top surface 65 between the raised position of FIG. 13 and the lowered position of FIG. 14.

Functionally the arrangement of the second embodiment otherwise operates substantially in accordance with the manner of operation of the earlier described embodiments in this specification.

The above describes only some embodiments of the present invention and modifications, obvious to those skilled in the art, can be made thereto without departing from the scope and spirit of the present invention.

In particular it is to be noted that whilst embodiments of the invention have been described by way of example utilizing solids refuse it will be understood that embodiments of the invention will work equally well for the compaction of other solids materials such as, but not limited to, rice hulls, bio fuels, certain types of wood chip and other compactable solids materials.

1. A compactor system for use in a refuse transfer station; said compactor comprising a refuse receiving volume for receipt of loose refuse; a refuse compacting device for compacting the loose refuse within said refuse receiving volume and wherein said compacting device is adapted to apply compacting force to said refuse in a vertical direction from below so as to form a compacted refuse load; a compacted refuse load transfer device for transferring the compacted refuse load to a refuse transport means.

2. The compactor system of claim 1 wherein said refuse compacting device applies compacting force in a substantially vertical direction to said loose refuse within said refuse receiving volume.

3. The compactor system of claim 1 or claim 2 wherein said refuse compacting device applies compacting force in a substantially vertical direction throughout the length and width of said refuse receiving volume.

4. The compactor system of claim 2 or claim 3 wherein said substantially vertical direction is a downward vertical direction from above said loose refuse.

5. The compactor system of claim 3 wherein said compacting force is released from said refuse sufficient to permit transferring the compacted refuse load to said refuse transport means.

6. The compactor system of any previous claim wherein said compacting force is applied to said loose refuse alternately in a downward vertical direction and an upward vertical direction.

7. The compactor system of any previous claim wherein said compacted refuse load transfer device transfers said compacted refuse load in a substantially horizontal direction.

8. The compactor system of claim 7 wherein said compacted refuse load transfer device transfers said compacted refuse load in one continuous movement.

9. The compactor system of any previous claim wherein said compacted refuse load transfer device transfers said compacted refuse load to said refuse transport means by urging of said compacted refuse load in a direction substantially perpendicular to the direction of operation of said refuse compacting device.

10. A refuse compacting device for use with the compactor system of any one of claims 1 to 9, said refuse compacting device incorporating compacting means which acts substantially perpendicular to a longitudinal axis of a refuse receiving volume defined within said refuse compacting device.

11. A method of compacting loose refuse at a refuse transfer station prior to transferring said refuse to a refuse transport means; said method comprising the steps of:
(a) loading up to a predetermined quantity of loose refuse into a refuse receiving volume;
(b) compacting said loose refuse so as to form a compacted refuse load by application of a compacting force to said loose refuse in a substantially vertical direction;
(c) releasing said compacting force from said refuse sufficient to permit transfer of said compacted refuse load from said refuse receiving volume to a refuse transport means.

12. A compactor system for use in a solids transfer station; said compactor system comprising a solids receiving volume for receipt of loose solids; a solids compacting device which acts substantially perpendicular to a longitudinal axis of said refuse receiving volume for compacting the loose solids within said solids receiving volume so as to form a compacted solids load; a compacted solids load transfer device for transferring the compacted solids load to a solids transport means; wherein said solids compacting device is adapted to the releasing of the compacting force sufficient to allow transfer of said compacted solids load.

13. The compactor system of claim 12 wherein said solids compacting device applies compacting force in a substantially vertical direction to said loose solids within said solids receiving volume.

14. The compactor system of claim 12 or claim 13 wherein said solids compacting device applies compacting force in a substantially vertical direction throughout the length and width of said solids receiving volume.

15. The compactor system of claim 13 or claim 14 wherein said substantially vertical direction is a downward vertical direction from above said loose solids.

16. The compactor system of claim 13 or claim 14 wherein said substantially vertical direction is an upward vertical direction from below said loose solids.

17. The compactor system of any one of claims 12 to 16 wherein said compacting force is applied to said loose solids alternately in a downward vertical direction and an upward vertical direction.

18. The compactor system of any one of claims 12 to 17 wherein said compacted solids load transfer device transfers said compacted solids load in a substantially horizontal direction.

19. The compactor system of claim 18 wherein said compacted solids load transfer device transfers said compacted solids load in one continuous movement.

20. The compactor system of any one of claims 12 to 19 wherein said compacted solids load transfer device transfers said compacted solids load to said solids transport means by urging of said compacted solids load in a direction substantially perpendicular to the direction of operation of said solids compacting device.

21. A solids compacting device for use with the compactor system of any one of claims 12 to 20, said solids compacting device incorporating compacting means which acts substantially perpendicular to a longitudinal axis of a solids receiving volume defined within said solids compacting device.

22. The compactor system of any one of claims 1 to 9 wherein operation of said compacted refuse load transfer device is independent of the operation of said refuse compacting device.

23. A method of compacting loose refuse at a refuse transfer station as claimed in claim 11; said method further including the step of transferring said compacted refuse load in a transfer step independent of said step of compacting.

24. A method of compacting loose solids at a solids transfer station prior to transferring said solids to a solids transport means; said method comprising the steps of:
(a) loading up to a predetermined quantity of loose solids into a solids receiving volume;
(b) compacting said loose solids so as to form a compacted solids load by application of a compacting force to said loose solids in a substantially vertical direction;
(c) releasing said compacting force from said solids sufficient to permit transfer of said compacted solids load from said solids receiving volume to a refuse transport means.

25. A compactor system for retrofitting to a transfer station; said compactor system comprising a moveable top surface adapted to move between a loading position and a compacting position; said compactor system further including a longitudinal transfer device; said top surface adopting a loading position during loading of solids into a pre-existing receiving volume; said moveable top surface adopting a compacting position located substantially over said receiving volume during compacting of said solids material; said longitudinal transfer device adapted to urge compacted solids material in a horizontal direction from said receiving volume following compaction of solids material therewithin.

26. The system of claim 25 wherein said longitudinal transfer device is operable independently of said moveable top surface.

27. The system of claim 25 or claim 26 wherein said transfer device urges compact material in one movement along the entire length of said top surface.

28. A method of retrofitting a pre-existing transfer station having a pre-existing volume therein; said method comprising adding to said transfer station a compactor system as claimed in any one of claims 1 to 9 or claim 22 or claim 27.

29. The method of claim 28 wherein said longitudinal transfer device is operable independently of said moveable top surface.

30. The method of claim 28 or claim 29 wherein said transfer device urges compact material in one movement along the entire length of said top surface.
